(19) United States
(12) Patent Application Publication
(10) Pub. No.: US 2007/0159850 A1
(43) Pub. Date: Jul. 12, 2007

(54) Color blend structure for improving the display of a backlight module of a liquid crystal display panel

(75) Inventors: Paul Yang, Taipei (TW); Shan-Yi Yu, Taipei County (TW); Chia Chien Lin, Taipei County (TW)

Correspondence Address: BACON & THOMAS, PLLC, 625 SLATERS LANE, FOURTH FLOOR, ALEXANDRIA, VA, 22314, US

(73) Assignee: HEALTH & LIFE CO., LTD, CHUNG HO CITY (TW)

(21) Appl. No.: 11/326,316

(22) Filed: Jan. 6, 2006

(51) Int. Cl. F21V 9/00; F21V 7/04

(52) U.S. Cl. 362/613; 362/604; 362/231

(57) ABSTRACT

A color blend structure for improving the display of a backlight module of an LCD panel includes a reflective sheet stacked with a light guide panel and at least two LEDs of different colors buried in a side of the light guide panel. The light guide panel includes a depressed opening disposed between the LEDs, and the light guide panel includes an LCD panel stacked thereon, such that when the LEDs produce colored lights of different colors, no light diffusion resulting a color blend will be produced due to the separation provided by the depressed opening and the reflection controlled at the edge of the depressed opening, such that when the LCD panel displays different color areas as warnings, users can view the warnings without any color confusion.

### BACKGROUND OF THE INVENTION

1. Field of the Invention

The present invention relates to a color blend structure for improving the display of a backlight module of a liquid crystal display (LCD) panel, and more particularly to a structure that installs a depressed opening at an appropriate position of a light guide panel, such that when light emitting diodes emit colored lights of different colors, the colored lights of different colors will not produce a light diffusion that results a color blend, and further will clearly display different colored light areas when a user views the LCD panel, so as to achieve the warning effect.

2. Description of the Related Art

Since more displays of electronic products adopt a liquid LCD panel for the display and also use backgrounds of different color to display results as warnings, therefore users can easily know the result and have a deep impression from the different color areas. For example, red color indicates a value exceeding a standard value or a predetermined value, and green color indicates a normal or standard value, and yellow color indicates a value close to a critical value that requires special attention.

Referring to FIGS. 1 and 2 for the general LCD panel used for an electronic sphygmomanometer, the LCD panel is installed on the surface of a casing 50 for displaying numbers, texts, or patterns, and the LCD panel 70 includes a reflective sheet 100 under the LCD panel 70. A light guide panel 90 stacked between the reflective sheet 100 and the LCD panel 70 and two light emitting diodes (LED) 80 buried in a side of the light guide panel 90, and the light emitting diode 80 can produce colored lights of different colors, and the light emitting diodes 80 keep a specific distance apart. The colored lights produced by the light emitting diodes 80 can enhance the background display effect of the LCD panel 70 by the light guide panel 90 and the reflective sheet 100, and the light emitting diodes 80 can use the preset display normal, reminding, or dangerous light colors to inform users about the measured results of blood pressures. In the light colors, a green color indicates a normal blood pressure; a yellow color indicates a blood pressure close to a critical value, and a red color indicates a blood pressure exceeding a critical value.

In the use of such device, if the user's measured systolic blood pressure is normal and the measured diastolic blood pressure exceeds a critical value, then the green and red colored lights produced by the light emitting diodes 80 will be reflected onto the back of the LCD panel 70 through the light guide panel 90 and the reflective sheet 100. However, when the colored lights are produced by the light emitting diode 80, the colored lights are diffused gradually outward at a specific angle, and thus the colored lights of different colors will be overlapped at the adjacent areas on the light emitting diodes 80 of the light guide panel 90, so as to produce a color blend effect and users cannot clearly view the results. The purpose of effectively enhancing the warning cannot be achieved, and thus the application of such device is not effective.

### SUMMARY OF THE INVENTION

In view of the foregoing shortcomings of the backlight display device of an LCD panel of a prior art electronic instrument, the inventor of the present invention developed a color blend structure for improving the display of a backlight module of a liquid crystal display panel in accordance with the present invention, in hope of using the structure of the present invention to achieve the effect of preventing a confused background of a displayed result, when the backlight module simultaneously displays different color areas, and thus improving the inconvenient use of the prior art.

Therefore, it is a primary objective of the present invention is to provide a color blend structure for improving the display of a backlight module of a liquid crystal display panel that is used for a backlight module structure for displaying two or more colors, and the structure includes a reflective sheet stacked with a light guide panel and at least two LEDs of different colors buried in a side of the light guide panel. The light guide panel includes a depressed opening disposed between the LEDs, and the light guide panel includes an LCD panel stacked thereon, such that when the LEDs produce colored lights of different colors, no light diffusion resulting a color blend will be produced due to the separation provided by the depressed opening and the reflection controlled at the edge of the depressed opening, such that when the LCD panel displays the measured results and different color areas as warnings, users can view the warnings without any color confusion, so as to deepen the user's impression.

Another objective of the present invention to provide a color blend structure for improving the display of a backlight module of a liquid crystal display panel that the depressed opening is cut into a V-shape slot that does not penetrate through the light guide panel or a rectangular groove that penetrates the light guide panel but not penetrates the whole backlight panel, so as to reduce the number of installed components and lower the manufacturing cost.

### BRIEF DESCRIPTION OF THE DRAWINGS

To make it easier for our examiner to understand the objective, shape, assembly, structure, characteristics and performance of the present invention, the following embodiments accompanied with the related drawings are described in details.

FIG. 1 is a top views of a prior art device;

FIG. 2 is a cross-sectional view of a prior art device;

FIG. 3 is top view of a first preferred embodiment of the present invention;

FIG. 3A is a side view of a first preferred embodiment of the present invention;

FIG. 3B is a cross-sectional view of a first preferred embodiment of the present invention;

FIG. 3C is a schematic enlarged view of a depressed opening according to a first preferred embodiment of the present invention;

FIG. 4 is a top view of a second preferred embodiment of the present invention;

FIG. 4A is a side view of a second preferred embodiment of the present invention;

FIG. 4B is a cross-sectional view of a second preferred embodiment of the present invention;

FIG. 4C is a schematic enlarged view of a depressed opening according to a second preferred embodiment of the present invention;

FIG. 5 is a top view of a third preferred embodiment of the present invention;

FIG. 5A is a side view of a third preferred embodiment of the present invention; and

FIG. 5B is a cross-sectional view of a third preferred embodiment of the present invention.

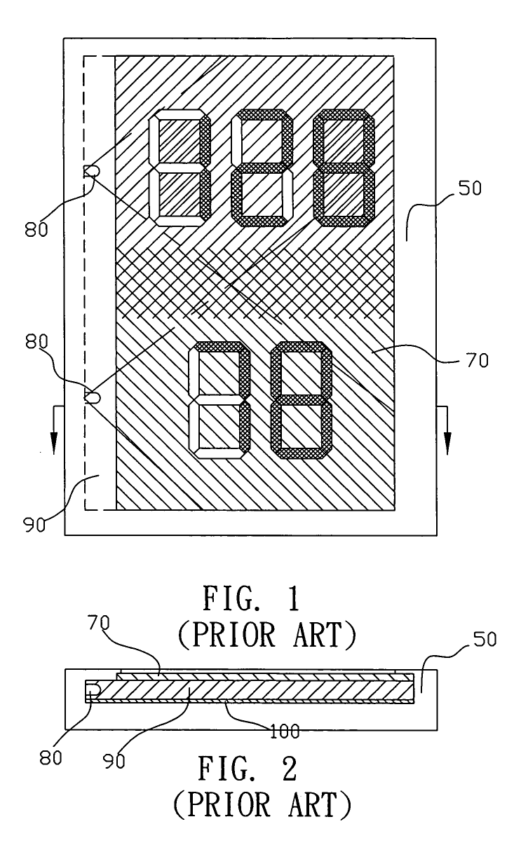

### DETAILED DESCRIPTION OF THE PREFERRED EMBODIMENTS

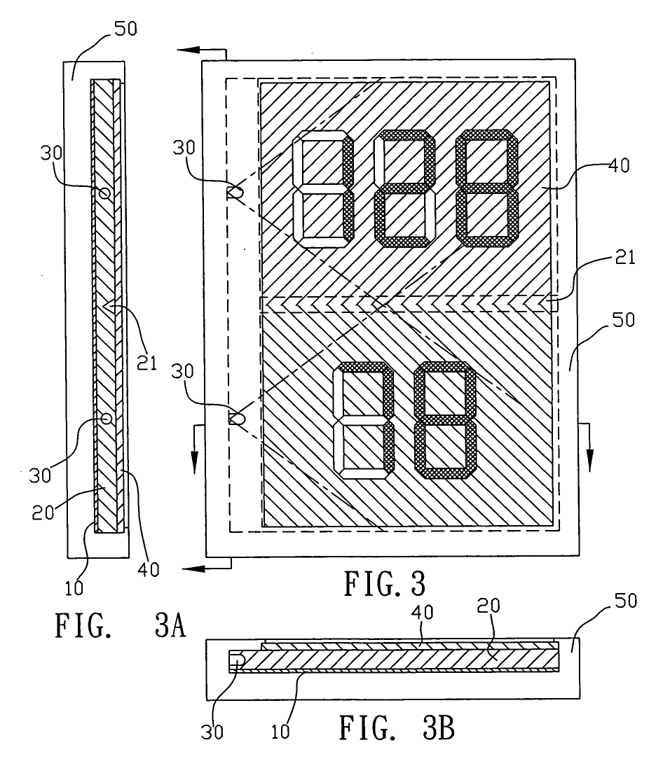

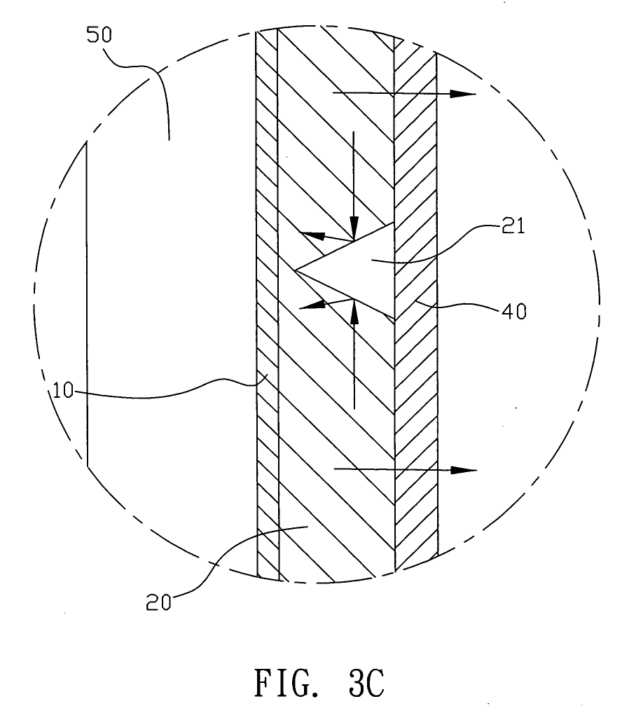

Referring to FIGS. 3, 3A, 3B, and 3C for the color blend structure for improving the display of a backlight module of a liquid crystal display panel according to a first preferred embodiment of the present invention, the preferred embodiment is used for an electronic sphygmomanometer, and those skilled in the art also can use the invention for other electronic products. The structure is installed on a casing 50 and comprises a reflective sheet 10 for reflecting a light, and the reflective sheet 10 includes a light guide panel 20 stacked thereon. One side of the light guide panel 20 is hidden in the casing 50, and two or more light emitting diodes (LED) 30 are buried into a side of the light guide panel 20, and the light emitting diodes 30 keep a specific distance apart. Further, the light guide panel 20 includes an LCD panel 40 stacked thereon for displaying a number, a text, or a pattern. The LCD panel 40 does not cover the position of the light emitting diodes 30 buried in the light guide panel 20, and the light guide panel 20 includes a V-shape depressed opening 21 that is not penetrated vertically (as shown in FIGS. 3A, 3B, and 3C) and disposed at the position of the light emitting diodes 30 and the depressed opening 21 is disposed among the light emitting diodes 30 (as shown in FIGS. 3A, 3B, and 3C), and the depressed opening 21 is transversally penetrated through the light guide panel 20 and extended to another side of the light guide panel 20, so as to keep the integrity of the whole light guide panel 20, and the size and position of the depressed opening 21 depend on the positions of the light emitting diodes 30 and the intensity of emitting the colored lights.

Referring to FIGS. 3 and 3A, the light emitting diodes 30 are driven to produce colored lights, and the reflective sheet 10 enhances the reflection of the colored lights. By the separation provided by the depressed opening 21 and the reflection in an opposition direction occurred at the edge of the depressed opening 21, the colored lights will not be overlapped or blended (as shown in FIG. 3) and thus will be projected clearly onto the background of the LCD panel 40, and users can easily view the measured number, text, or pattern. The colored lights with different color area backgrounds can enhance the effect of warning users and make the whole display module more artistic.

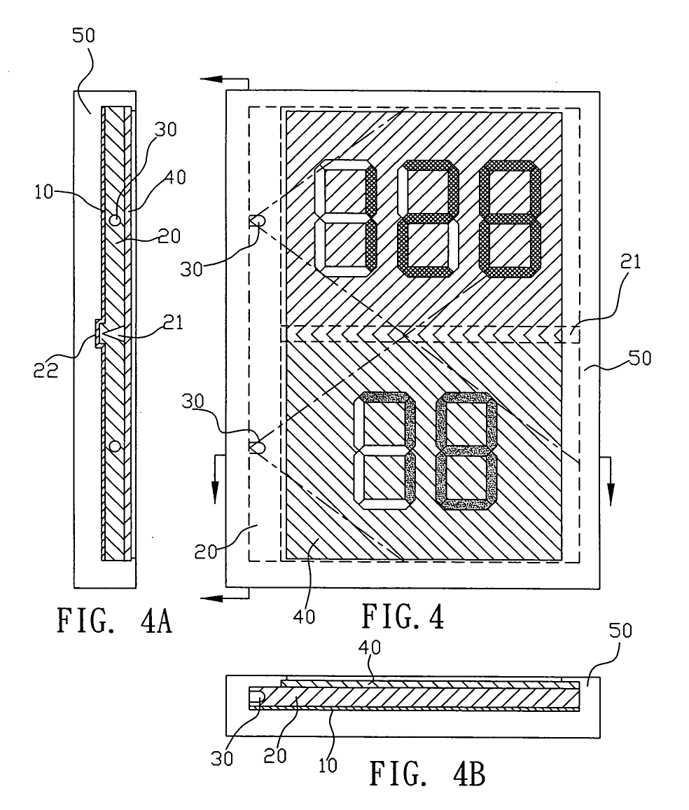

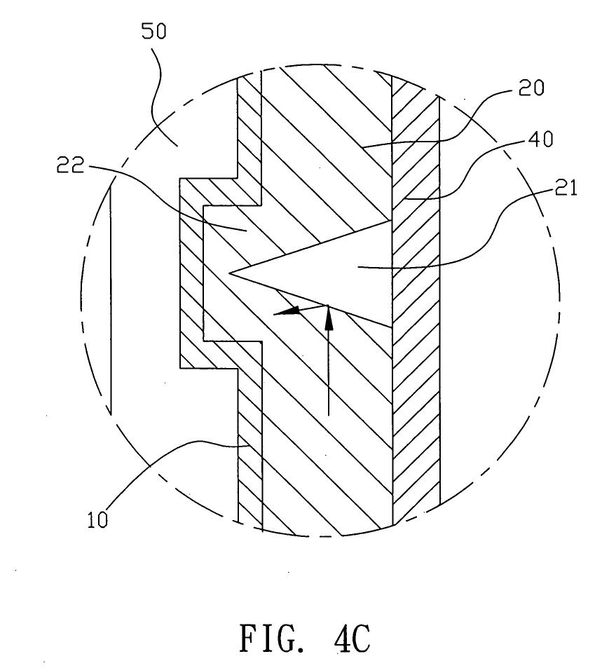

Referring to FIGS. 4, 4A, 4B, and 4C for the second preferred embodiment of the present invention, the structure installed on a casing 50 comprises a reflective sheet 10 for reflecting a light, and a light guide panel 20 stacked on the reflective sheet 10. One side of the light guide panel 20 is hidden into the casing, and the light guide panel 20 at that side buries at least two light emitting diodes (LED) 30, and the light emitting diode 30 keep a specific distance apart. The light guide panel 20 includes an LCD panel 40 stacked thereon for displaying a number, a text, or a pattern, and the LCD panel 40 is installed at the light guide panel 20 at the position of the light emitting diodes 30, and the light guide panel 20 includes a V-shape depressed opening 21 (as shown in FIGS. 4A, 4B, and 4C) disposed at a position without the light emitting diodes 30 and having a thickness equal to or greater than the thickness of the light guide panel 20. The depressed opening 21 is disposed among the light emitting diodes 30 (as shown in FIGS. 4A, 4B, and 4C), and the depressed opening 21 is penetrated transversally through the light guide panel 20 and extended to another side of the light guide panel 20. A protruding member is protruded from the light guide panel 20 and disposed at a corresponding position of the depressed opening 21 for increasing the thickness at that position, and maintaining the integrity of the whole light guide panel 20 (as shown in FIGS. 4A and 4C), and the size and position of the depressed opening 21 depend on the position of the light emitting diodes 30 and the intensity of the emitting the colored lights.

Referring to FIGS. 4 and 4A, the light emitting diodes 30 are driven to produce colored lights, and the reflective sheet 10 enhances the reflection of the colored lights. By the separation provided by the depressed opening 21 and the reflection in an opposition direction occurred at the edge of the depressed opening 21, the colored lights will not be overlapped or blended (as shown in FIG. 4) and thus will be projected clearly onto the background of the LCD panel 40, and users can easily view the measured number, text, or pattern. The colored lights with different color area backgrounds can enhance the effect of warning users and make the whole display module more artistic.

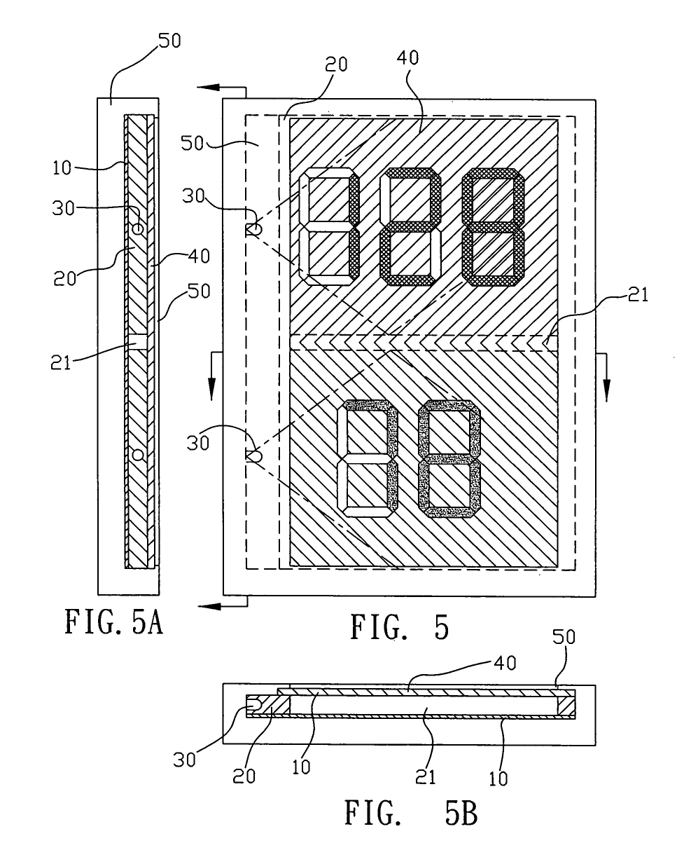

Referring to FIGS. 5, 5A, and 5B for the third preferred embodiment of the present invention, the structure installed on a casing 50 comprises a reflective sheet 10 for reflecting a light, and a light guide panel 20 stacked on the reflective sheet 10. One side of the light guide panel 20 is hidden into the casing, and the light guide panel 20 at that side buries at least two light emitting diodes (LED) 30, and the light emitting diode 30 keep a specific distance apart. The light guide panel 20 includes an LCD panel 40 stacked thereon for displaying a number, a text, or a pattern, and the LCD panel 40 is installed at the light guide panel 20 at the position without the light emitting diodes 30, and the light guide panel 20 includes a rectangular depressed opening 21, but those skilled in the art can use other shapes for the depressed opening, and the depressed opening 21 is disposed among the light emitting diodes 30 (as shown in FIGS. 5A and 5B). The depressed opening 21 is extended to another side of the light guide panel 20 without penetrating transversally through the light guide panel 20, so as to keep the integrity of the whole light guide panel 20 (as shown in FIG. 5A), and the size and position of the depressed opening 21 depend on the position of the light emitting diodes 30 and the intensity of the emitting the colored lights.

Referring to FIGS. 5 and 5A, the light emitting diodes 30 are driven to produce colored lights, and the reflective sheet 10 enhances the reflection of the colored lights. By the separation provided by the depressed opening 21 and the reflection in an opposition direction occurred at the edge of the depressed opening 21, the colored lights will not be overlapped or blended (as shown in FIG. 5) and thus will be projected clearly onto the background of the LCD panel 40, and users can easily view the measured number, text, or pattern. The colored lights with different color area backgrounds can enhance the effect of warning users and make the whole display module more artistic.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color blend structure for improving the display of a backlight module of a liquid crystal display panel, comprising:
a reflective sheet, for reflecting a light;
a light guide panel, stacked on said reflective sheet and having at least two light emitting diodes disposed on a side of said light guide panel, and said light emitting diode emits a colored light of a different color according to a predetermined display result, and said light emitting diodes keep a specific distance apart, and a depressed opening is disposed between said light guide panel and said light emitting diodes, and said depressed opening does not vertically penetrate said light guide panel, and said depressed opening is extended transversally from a side of said light guide panel to another side of said light guide panel; and
a liquid crystal display panel, stacked on said light guide panel for displaying a number, a text, or a pattern;
such that when said light emitting diode capable of producing different colors produces a colored light, the separation provided by said depressed opening and the reflection occurred at the edge of said depressed opening prevent an overlapped color blend, and thus when said liquid crystal display panel displays a result, different colored light background areas can be produced, so as to prevent a color confusion.

2. The color blend structure for improving the display of a backlight module of a liquid crystal display panel of claim 1, wherein said light emitting diode can produce a red, green, or yellow light.

3. The color blend structure for improving the display of a backlight module of a liquid crystal display panel of claim 2, wherein said depressed opening is a V-shape slot.

4. The color blend structure for improving the display of a backlight module of a liquid crystal display panel of claim 1, further comprising a protruding member disposed between said light guide panel and said depressed opening for increasing the thickness of said light guide panel and further maintaining the integrity of said light guide panel.

5. A color blend structure for improving the display of a backlight module of a liquid crystal display panel, comprising:
a reflective sheet, for reflecting a light;
a light guide panel, stacked on said reflective sheet and having at least two light emitting diodes disposed on a side of said light guide panel, and said light emitting diodes produce a colored light of a different color and keep a specific distance a part, and a depressed opening is disposed between said light guide panel and said light emitting diodes, and said depressed opening vertically penetrates said light guide panel, and said depressed opening is extended transversally from a side of said light guide panel to another side of said light guide panel, but not completely traversing said light guide panel; and
a liquid crystal display panel, stacked on said light guide panel for displaying a number, a text, or a pattern;
such that when said light emitting diode capable of producing different colors produces a colored light, the separation provided by said depressed opening and the reflection occurred at the edge of said depressed opening prevent an overlapped color blend, and thus when said liquid crystal display panel displays a result, different colored light background areas can be produced, so as to prevent a color confusion.

6. The color blend structure for improving the display of a backlight module of a liquid crystal display panel of claim 5, wherein said light emitting diode can produce a red, green, or yellow light.

7. The color blend structure for improving the display of a backlight module of a liquid crystal display panel of claim 5, wherein said depressed opening is a rectangular groove.
